(19) United States
(12) Patent Application Publication
(10) Pub. No.: US 2006/0213869 A1
(43) Pub. Date: Sep. 28, 2006

(54) Method for controlling a CMP process and polishing cloth

(75) Inventor: Roland Rzehak, Dresden (DE)

Correspondence Address: MORRISON & FOERSTER LLP, 1650 TYSONS BOULEVARD, SUITE 300, MCLEAN, VA, 22102, US

(73) Assignee: INFINEON TECHNOLOGIES AG, Munchen (DE)

(21) Appl. No.: 11/377,638

(22) Filed: Mar. 17, 2006

(30) Foreign Application Priority Data
Mar. 18, 2005 (DE) 10 2005 012 684.7

(51) Int. Cl. B24B 1/00; C03C 15/00; B24B 7/19; C23F 1/00

(52) U.S. Cl. 216/88; 216/84; 451/28

(57) ABSTRACT

The invention relates to a method for controlling a CMP process with a polishing cloth, by which a surface of a substrate is polished, the polishing procedure being controlled on the basis of at least one process parameter, allowance for a height distribution of the surface of the polishing cloth, in particular a range of the height distribution, being made in the control of the CMP process. Furthermore, the invention relates to a polishing cloth for a CMP process with a surface which has a height distribution, the height distribution having a range which is less than 3 μm.

### CLAIM FOR PRIORITY

This application claims the benefit of priority to German Application No. 10 2005 012 684.7, filed Mar. 18, 2005, the contents of which are hereby incorporated by reference.

### TECHNICAL FIELD OF THE INVENTION

The invention relates to a method for controlling a CMP process, a method for determining a polishing performance of a CMP process, a method for controlling a conditioning procedure for a polishing cloth in a CMP process and a polishing cloth.

### BACKGROUND OF THE INVENTION

In the area of semiconductor technology, in particular in the production of semiconductor memories, the chemical-mechanical polishing process (CMP) has been found to be an important method for producing integrated circuits since narrow trench isolation structures became widely used. During the CMP process, the substrate surface is polished with a polishing cloth using a polishing fluid, the surface of the substrate being removed. The chemical-mechanical polishing method is very sensitive with respect to different structures of the substrate surface, so that it is possible for deposits of conductive metal lines and washing out of dielectric materials to occur. Since the nature of the surface of the substrate after the CMP process has a great influence on the yield, many efforts are made to gain an exact understanding of the CMP process.

It is known for a polishing cloth to be subjected after a fixed polishing time to a conditioning procedure in which the polishing cloth is reworked with the aid of a conditioning tool, in this case with the aid of diamonds, the surface of the polishing cloth being abrasively removed and brought into a predetermined initial state.

An optical device and an optical method by which the surface structure of a CMP polishing cloth can be sensed are known. The method is suitable for sensing the layer thickness of the polishing cloth that is abrasively removed during the polishing procedure or during the conditioning procedure. Moreover, with the optical interferometer described, the surface roughness of the polishing cloth can be determined. In this respect, it has been found that the surface roughness of the polishing cloth is increased during the conditioning of the polishing cloth. Moreover, it has been found that a greater surface roughness leads to a greater rate of removal during the polishing method.

Furthermore, it is known that the surface roughness of the polishing cloth is influenced by the conditioning procedure. In this respect, a completely conditioned polishing cloth exhibits a virtually Gaussian distribution with respect to the height structure. By contrast, the height distribution of the surface structure of the polishing cloth changes to a strong maximum in the vicinity of the surface of the polishing cloth during the CMP polishing method. The distribution of the orthocenters of the surface structure can be differently set with the aid of different conditioning methods.

Moreover, it is known that the surface roughness of a CMP polishing cloth has an influence on the rate of removal during the CMP process. In the arrangement described, a proportional relationship is found between the average surface roughness and the average rate of removal.

Furthermore, there are known mathematical models for the chemical-mechanical polishing method, which make various assumptions concerning the height distribution of the surface structure of the polishing cloth.

An exponential height distribution has been assumed. However, verification of this assumption by a direct quantitative comparison with experimental data has not been performed. Moreover, a height distribution of the Preston iv type with parameters determined from roughness measurements has been assumed. There is an approximate qualitative match between the model predictions and data from polishing tests. However, apart from the roughness of the polishing cloth, the model includes a number of further effects, the relative significance of which for actual polishing processes not having been investigated any further.

### SUMMARY OF THE INVENTION

One embodiment of the invention relates to an improved method for controlling a CMP process. Furthermore, the invention relates to an improved method for determining a polishing performance of a CMP process. Moreover, the invention relates to an improved method for controlling a conditioning procedure for a polishing cloth. Furthermore, the invention relates to an improved polishing cloth and an improved quality system for polishing cloths.

In another embodiment the invention relates to a method for controlling a CMP process with a polishing cloth, by which a surface of a substrate is polished, the polishing procedure being controlled on the basis of at least one process parameter, allowance for a height distribution of the surface of the polishing cloth, in particular a range of the height distribution, being made in the control of the CMP process.

In still another embodiment the invention also relates to a method for determining a polishing performance of a CMP process of a substrate with a polishing cloth, by which an upper surface and a set-back surface of the substrate are subjected to a polishing procedure with the polishing cloth, allowance for a height distribution of the surface of the polishing cloth, in particular a range of the height distribution, being made in the determination of the polishing performance for the upper surface and/or the set-back surface.

Moreover, in yet another embodiment, the invention relates to a method for controlling a conditioning procedure for a polishing cloth in a CMP process, in which a surface of a substrate is polished with a polishing cloth, the polishing cloth being subjected to a conditioning procedure, the polishing cloth being worked with a conditioning device during the conditioning procedure in order to produce a desired surface property of the polishing cloth, allowance for the height distribution of the surface of the polishing cloth, in particular the range of the height distribution, being made for the beginning and/or the control of the conditioning procedure.

Furthermore, the invention relates to a polishing cloth for a CMP process with a surface which has a height distribution with a range which is less than 3 μn.

### BRIEF DESCRIPTION OF THE DRAWINGS

The invention is explained in more detail below on the basis of the figures, in which:

FIG. 1 shows a CMP arrangement.

FIG. 2 shows a height distribution of a surface structure of a polishing cloth.

FIG. 3 shows the height distribution of a polishing cloth.

FIG. 4 shows a substrate with a polishing cloth.

FIG. 5 shows a height distribution of the surface structure of the polishing cloth.

FIG. 6 shows the mathematical model for the polishing cloth.

### DETAILED DESCRIPTION OF THE INVENTION

One advantage of the method is that the CMP process can be controlled more precisely. This is achieved by allowance for the height distribution of the surface structure of the polishing cloth being made in the control of the CMP process. Contrary to the view previously taken in the prior art, tests have shown that the height distribution of the surface structure of the polishing cloth has an influence on the polishing performance of the polishing cloth, and consequently an influence on the CMP process. In particular in the case of substrates with a graduated surface, the allowance for the height distribution of the surface structure of the polishing cloth is a parameter which influences both the planarity and the rate of removal both on upper surface regions of the substrate and on set-back surface regions of the substrate. Consequently, more precise control of the CMP process is made possible by allowance being made for the height distribution of the surface structure of the polishing cloth.

In a further embodiment of the method, depending on the height distribution of the surface structure of the polishing cloth, a polishing duration for the CMP process is determined and allowance made for it in the control of the CMP process. Consequently, a parameter of the CMP process is adapted by the height distribution of the surface structure of the polishing cloth. Apart from the height distribution of the surface structure of the polishing cloth, allowance for further parameters may also be made for determining the polishing duration of the CMP process.

In a further embodiment of the method, allowance for the height structure of the substrate, which likewise has an important influence on the CMP process, is made in the control of the CMP process. In this respect, either the height structure is determined during the CMP process or previously determined data on the height structure are used and allowance made for them in the control of the CMP process.

Furthermore, depending on the size of an upper surface and depending on the size of a recessed surface of the substrate, allowance can be made for the height structure. In this way, a simple and adequately precise measure of the influencing of the CMP process is used.

In a further embodiment of the method, a theoretical model is used for determining the effect of the polishing cloth in the CMP process, the theoretical model making allowance for a height distribution of the surface structure of the polishing cloth.

In a further embodiment of the theoretical model, a multiplicity of spring elements, in particular Hook's spring elements, are used for the simulation of the operating mode of the polishing cloth. Tests have shown that this theoretical model makes a simple simulation possible and, moreover, provides an adequately precise description of the mechanical operating mode of the polishing cloth.

In a further embodiment of the method, a removal performance of the CMP process for the recessed surfaces is determined on the basis of the height distribution of the surface structure of the polishing cloth. In particular for the recessed surfaces of the substrate, the height distribution of the surface structure of the polishing cloth represents an important variable with respect to the removal performance. In this way, the control of the CMP process is improved by allowance being made for the removal performance in dependence on the height distribution of the surface structure of the polishing cloth for the recessed surfaces.

An advantage of one embodiment of the method can be seen in that the polishing performance of the CMP process can be described more exactly. This is achieved by allowance for the height distribution of the surface of the polishing cloth being made in the determination of the polishing performance for the upper surface and/or the recessed surface of the substrate.

According to one embodiment of the method, a method for controlling the conditioning procedure of the polishing cloth of a CMP process is improved, in which allowance for the height distribution of the surface structure of the polishing cloth is made for the start and/or the end and/or the manner of the conditioning procedure. By making allowance for the height distribution of the surface structure of the polishing cloth, a conditioning method which is more precise and adapted to the desired result is achieved.

One embodiment of the polishing cloth may have the advantage that an improved polishing performance is achieved in the case of a graduated surface structure by the fixed range of the height distribution. In particular, polishing of surfaces arranged in a recessed state is reduced or avoided. As a result, substantially only the upper surfaces of the substrate are polished and removed. It is consequently possible to carry out the CMP process more efficiently.

A further embodiment of the polishing cloth has the advantage that a user can make a better classification of the properties of the polishing cloth on the basis of the quality class. The polishing cloth can be selected according to the quality class and used for the appropriate CMP process. In dependence on the height structure of the substrate, polishing clothes of various quality classes can be used.

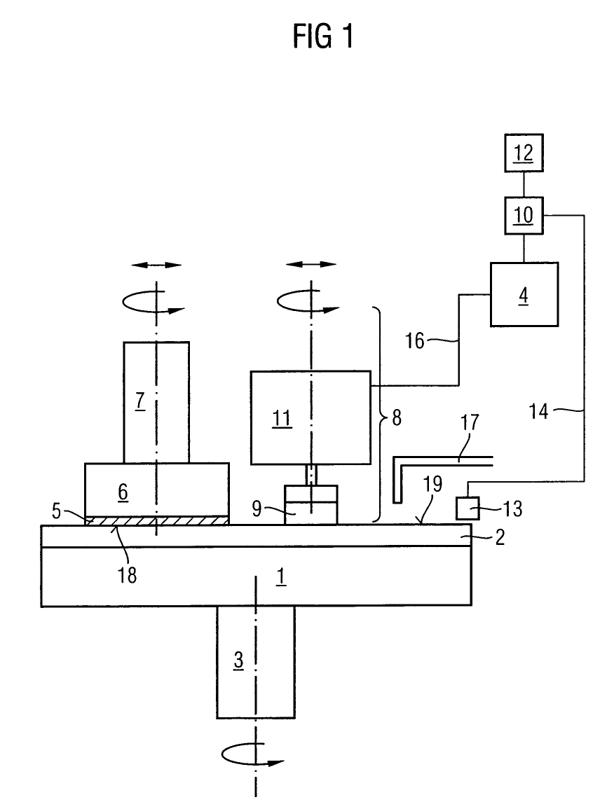

FIG. 1 shows an arrangement for carrying out a CMP polishing method in a schematic representation. The arrangement has a polishing cloth holder 1, on which a polishing cloth 2 is fastened. The polishing cloth holder 1 is in connection with a drive unit 4 via a drive shaft 3. The polishing cloth holder 1 is mounted in such a way that it can be rotated by means of the drive unit 4 in a longitudinal axis of the drive shaft 3. Resting on the polishing cloth 2 is a substrate 5 in the form of a wafer, for example a silicon wafer. The substrate 5 is fastened to a substrate holder 6, which is likewise in connection with the drive unit 4 via a second drive shaft 7. The drive unit 4 is formed in such a way that the substrate holder 6 is both rotatable about a center axis of the second drive shaft 7 and mounted in such a way that it is displaceable parallel to the surface of the polishing cloth 2. Moreover, the polishing cloth holder 1 and the substrate holder 6 may be clamped with respect to each other. This allows the frictional force between the polishing cloth and the substrate to be set, and consequently the speed of the removal process to be influenced.

Also provided is a conditioning device 8, which has a second drive unit 11 with a grinding plate 9. With the aid of the second drive unit 11, the grinding plate 9 is pressed with a fixed prestress against a polishing cloth surface 19. Moreover, by means of the drive unit 11, the grinding plate 9 can be rotated about itself, about a center axis, and moreover can be displaced along a straight line of movement which is formed radially in relation to the circular center point of the polishing cloth 2. This allows the grinding plate 9 to be moved back and forth between the center point of the polishing cloth 2, which is fixed by the center axis of the drive shaft 3, and the edge region of the polishing cloth 2.

The second drive unit 11 is in connection with the drive unit 4 via a control line 16. The drive unit 4 in turn has a control unit 10, to which the data memory 12 is assigned. Depending on the stored control programs, which are stored in the data memory 12, the control unit 10 controls the CMP process. In this respect, the control unit 10 makes allowance for sensor signals which are provided by sensors 13 and describe a physical and/or chemical variable of the CMP polishing process. For this purpose, the sensors 13 are connected to the control unit 10 via sensor lines 14.

The operating mode of the CMP polishing arrangement according to FIG. 1 is explained hereafter: at the beginning of the CMP process, the substrate 5 is placed by the drive unit 4 with a substrate surface 18 onto a polishing cloth surface 19. At the same time, a desired prestress of the substrate 5 with respect to the polishing cloth 2 is set. Moreover, polishing fluid is applied to the polishing cloth surface 19 via a supply line 17. The polishing fluid may contain chemical additives and/or mechanical particles which assist the polishing procedure.

Subsequently, the polishing cloth holder 1 is set in a rotational movement about the center axis of the drive shaft 3. Moreover, the substrate holder 6 is set in a rotational movement, corresponding to the center axis of the second drive shaft 7. Furthermore, the substrate holder 6 is additionally set in a reciprocating movement, in which the substrate 5 is moved back and forth between the center point and an edge region of the polishing cloth 2. In the embodiment represented, the center point of the polishing cloth 2 is arranged above the center axis of the drive shaft 3.

In dependence on the chosen embodiment, the conditioning device 8 is either used continuously during the polishing procedure, or activated in dependence on fixed operating parameters. When the conditioning device 8 is used, the second grinding plate 9 is pressed against the polishing cloth surface 19 with the aid of the second drive unit 2. Moreover, the grinding plate 9 is set in a rotational movement about its own center axis and additionally subjected to a reciprocating movement, so that the grinding plate 9 is moved back and forth between the center point of the polishing cloth 2 and an edge region of the polishing cloth 2. With the aid of the grinding plate 9, which may for example have diamonds on the surface, the polishing cloth 2 is roughend, and a leveling of the surface structure of the polishing cloth 2 is thereby counteracted by the polishing procedure on the substrate 5.

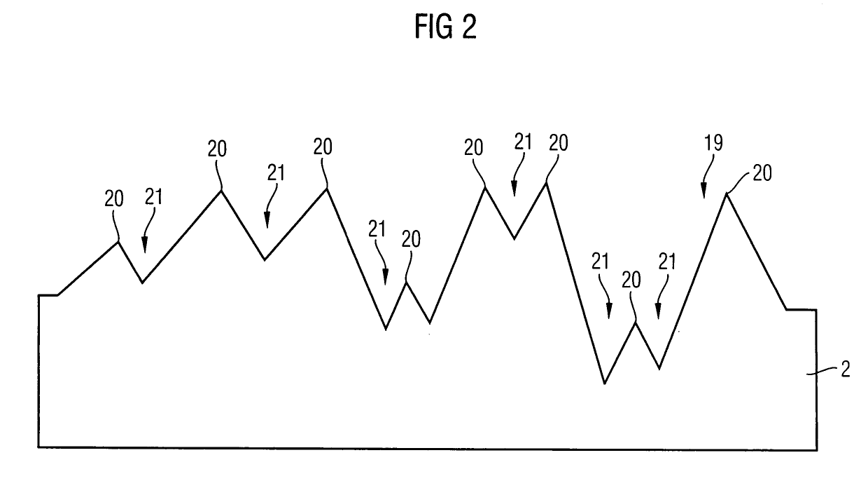

FIG. 2 shows a schematic representation of the surface structure of the polishing cloth surface 19 of the polishing cloth 2. It can be seen from FIG. 2 that the surface structure of the polishing cloth 2 is by no means planar, but has a multiplicity of peaks 20 and valleys 21 lying in between. The polishing cloth represented takes the form of a polyurethane polishing cloth. The arrangement of the peaks 20 and valleys 21 represents a surface structure of the polishing cloth 2. The surface structure of the polishing cloth 2, and with it the orthocenters of the peaks 20 and the depths of the valleys 21, represent important parameters which influence the polishing performance of the polishing cloth 2.

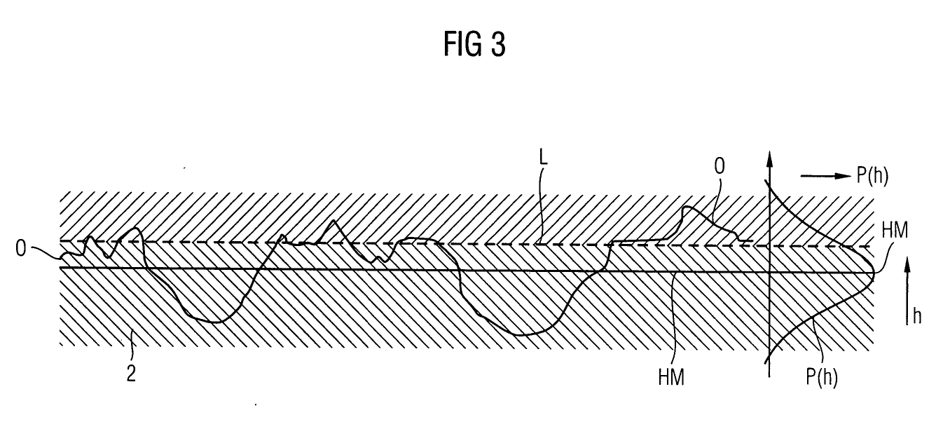

FIG. 3 shows a further surface structure O of a polishing cloth in a schematic representation. The average height of the surface structure is represented by the line HM. Also represented is a line L, which is depicted at the height above the substrate from which the surface of the polishing cloth touches the surface of the substrate. This means that only the surface regions of the polishing cloth that are arranged above the line L touch the substrate. The line L lies significantly above the line HM.

At the right-hand edge, the height distribution P(h) of the surface structure over the height h is represented. Since only the upper region of the surface structure actually comes into contact with the surface of the substrate during the polishing procedure, it follows that the range of the height distribution is an important measure of the polishing property. In the chosen exemplary embodiment, a virtually exponential distribution of the surface structure is obtained for that part of the surface above the line L, on the basis of the following formula: P(h)=s exp(−h/s), P designating the probability of encountering a orthocenter h on the polishing cloth, and s indicating the standard deviation and the mean value of the orthocenters of the surface.

It is in principle possible to deduce the relationship that, the smaller the range of the height distribution, characterized by the value of s, the lower the rate of removal in graduated or set-back surfaces of the substrate. The greater the range of the height distribution, the greater the polishing rate and rate of removal of set-back surfaces of the substrate. Good results have been determined for polishing cloths of which the range of height distribution is less than 4 μm, in particular less than 3 μm. Better results have been determined for polishing cloths of which the range of height distribution is less than 3 μm, in particular less than 1.5 μm.

On the basis of the findings described, it is advantageous to classify the polishing cloths in quality classes according to range spans for the height distribution. The first quality class comprises polishing cloths with a range greater than 3 μm. The second quality class comprises range spans for the height distribution between 1.5 m and 3 μm. The third quality class comprises height distributions with a range less than 1.5 μm. In dependence on the substrate to be polished, a polishing cloth of an appropriate quality class is then chosen and used. Since production parameters have to be maintained more precisely for a smaller range of the height distribution, the polishing cloth with the smaller range of height distribution is more expensive to produce. It is consequently possible to use an adapted polishing cloth, corresponding to the substrate in question. Costs are saved in this way.

If, however, a substrate with low graduations is to be polished, the set-back surfaces not requiring polishing, a substrate with a small range, preferably with a range which is less than the distance between the upper surface and the set-back surface, must be chosen.

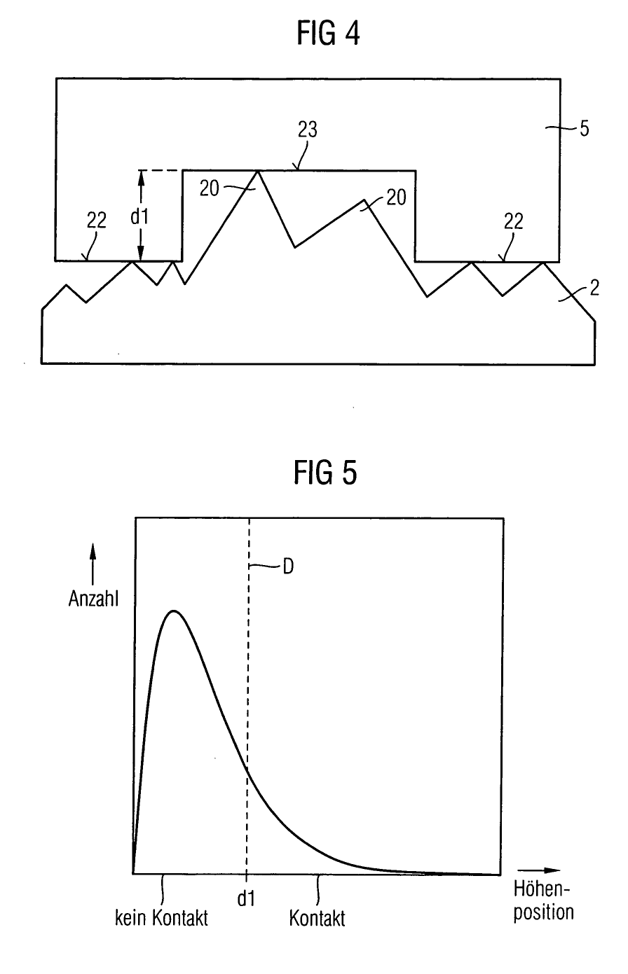

FIG. 4 shows a schematic representation in which a substrate 5 with an upper surface 22 and a set-back surface 23 is polished with a polishing cloth 2. The upper surface 22 is arranged higher than the set-back surface 23 by the distance d1. In this case, the polishing cloth surface 19 does not rest on the set-back surface 23 with all the peaks 20 that are formed on the polishing cloth 2 in the region of the set-back surface 23. In dependence on the number of resting peaks 20, both the rate of removal and the planarity during removal of the substrate 5 are influenced. In particular, the removal performance during the CMP process for the set-back surfaces 23 is influenced by the orthocenters of the surface structure of the polishing cloth 2.

If in the given situation, polishing or removal of the set-back surface is to be prevented, a polishing cloth with a range of the height distribution which is less than the distance d1 between the upper surface 22 and the set-back surface 23 is to be used. In this case, however, it is assumed that the rigidity of the polishing cloth is sufficient, so that the polishing cloth does not bend, or only insignificantly.

FIG. 5 shows a height distribution of the surface structure of a polishing cloth 2, the number of peaks 20 plotted against the orthocenter of the peaks 20. In the diagram, a line D is also entered at the orthocenter which corresponds to the depth d1 of the set-back surface 23. This means that all the peaks 20 at a orthocenter which is less than the depth d1 are not brought into contact with the set-back surface 23 during the polishing procedure.

The height distribution of the surface structure of the polishing cloth surface 19 can be determined for example with atomic force microscopy (AFM) or electron scanning microscopy or with the aid of optical, interferometric methods.

Tests have shown that the distribution of the orthocenters, as represented in FIG. 5, represents an important influencing variable for the polishing procedure. Therefore, contrary to the prior art, the distribution of the orthocenters of the polishing cloth surface 19 is used for controlling the CMP process, for determining a polishing performance of a CMP process and for controlling a conditioning procedure.

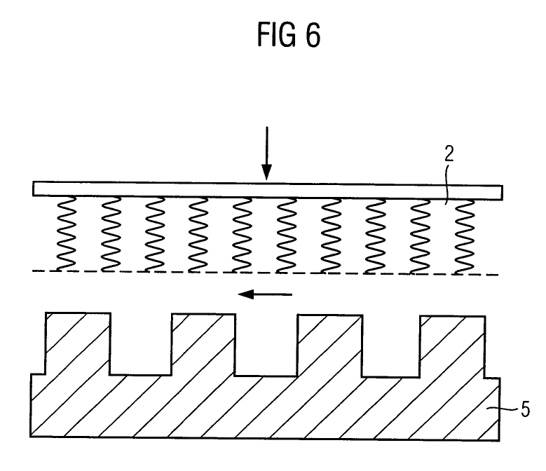

FIG. 6 shows a schematic representation of the theoretical model which is used for determining the polishing properties of the polishing cloth 2. In the case of this model, the polishing cloth 2 is simulated in the form of spring elements, in particular Hook's spring elements. The theoretical model is used for the purpose of determining the local pressure between the polishing cloth 2 and the surface of the substrate 5. In the polishing procedure, the upper surface 22 and the set-back surface 23 are to be differentiated. On the basis of the height structure of the substrate 5 and the height distribution of the surface structure of the polishing cloth surface 19, a first part of the pressure is exerted on the upper surface 22 and a second part of the pressure is exerted on the set-back surface 23. Two cases are to be differentiated here. In the first case, only the upper surface comes into contact with the springs, and the pressure on the upper surface results from the externally exerted pressure by allowance being made for the reduced contact surface area. In the second case, both the upper surface and the set-back surface come into contact with the springs. According to Hook's law, the pressure difference between the upper surface 22 and the set-back surface 23 is then proportional to the distance d1 by which the set-back surface 23 is set back from the upper surface 22, while the total sum of the pressures which are exerted on the upper surface 22 and on the set-back surface 23 must correspond to the externally exerted overall pressure. Indications as to the rate of removal during the polishing procedure can be determined with allowance for Preston's law. The rate of removal for the polishing procedure for the upper surface 22 and the set-back surface 23 can be determined in dependence on the step height d1 according to a standard model in the following way:

$$\begin{matrix}{RR}^{up} = \frac{RR}{ρ} , & {RR}^{down} = 0 & for h \geq {h}_{c} \\ {RR}^{up} = \frac{RR}{ρ} - \frac{ρ - 1}{τ} h , & {RR}^{down} = RR - \frac{ρ}{τ} h & for h \geq {h}_{c}\end{matrix} \qquad ( 1 )$$

where the rate of removal RR and the time constant τ represent parameters which can be determined experimentally. The value h designates the step height d1. In dependence on the pressure P and the relative speed between the polishing cloth 2 and the substrate 5, with allowance for Preston's law the rate of removal is obtained as RR=KPV, where K represents a Preston coefficient. For the simple, elastic polishing cloth model used, the following definition is obtained: τ=L₀/(EKV), where L₀ represents the length of the spring elements and E represents Young's modulus. The so-called contact height h_{c} represents the greatest step height at which the set-back surface 23 can still be touched by the polishing cloth. The contact height is obtained in the following way:

$${h}_{c} = h ( {τ}_{c} ) = \frac{τ RR}{ρ} = \frac{{PL}_{0}}{E ρ} \qquad ( 2 )$$

where τ_{c} designates the contact time. The sample density p describes the surface ratio between the upper surface 22 and a fixed reference surface, which is preferably determined experimentally. In dependence on the chosen mathematical model, a weighted average function may also be used for the sample density ρ. For example, ρ can be defined in the following way:

$$ρ ( x , y ) = \frac{1}{2 π {IL}^{2}} \int \int χ ( {x}^{′} , {y}^{′} ) exp ( - \frac{{( x - {x}^{′} )}^{2} + {( y - {y}^{′} )}^{2}}{2 {IL}^{2}} ) ⅆ {x}^{′} ⅆ {y}^{′} \qquad ( 3 )$$

where an interaction length IL is used as an additional model parameter. The characteristic function χ (x, y) is predetermined by the geometry of the structure to be planarized. To resolve equations 1 for a fixed value of the sample density, the two formulas are combined in a single, closed differential equation for the step height, the step height being entered linearly and therefore allowing the differential equation to be analytically resolved. When the solution is entered in equations 1, the height of the upper surface 22 and of the set-back surface 23 can be obtained by a simple integration, which can likewise be analytically resolved.

According to the further development of the theoretical model on the basis of the inventive teaching, allowance for the height distribution of the surface structure of the polishing cloth surface 19 is made by the length of the springs being assumed according to the height distribution of the surface structure.

The rates of removal for the upper surface 22 and the set-back surface 23 are calculated by integration of the contributions of each spring according to equations 1 with the corresponding height distribution of the surface structure. On the basis of the proportional dependence between the spring length and the contact height, as described in equation 2, an equivalent distribution of the contact height can be assumed.

Viewed in this way, the influence of the surface roughness of the polishing cloth surface 19, i.e. the height distribution of the surface structure, on the polishing procedure becomes clear. The longer the spring elements are, the greater the probability of the spring elements touching and removing the set-back surface 23 at an earlier point in time during the polishing process. This makes it clear which of the two equations in formula group 1 can be applied for a specific spring length. All spring elements of which the contact height is greater than the step by which the set-back surface 23 is set back from the upper surface 22 come into contact with the set-back surface 23. This results in the following formulas for the rate of removal with respect to the upper surface 22 and the set-back surface 23:

$$\begin{matrix}{RR}^{up} = {\int }_{{h}_{c} = - ∞}^{{h}_{c} = h} \frac{RR}{ρ} P ( {h}_{c} ) ⅆ {h}_{c} + {\int }_{{h}_{c} = h}^{{h}_{r} = ∞} RR - \frac{ρ - 1}{τ} hP ( {h}_{c} ) ⅆ h & ( 3 a ) \\ {RR}^{down} = {\int }_{{h}_{r} - h}^{{h}_{c} - ∞} RR - \frac{ρ}{τ} hP ( {h}_{c} ) ⅆ {h}_{c} & ( 3 b )\end{matrix}$$

In FIG. 4, a Pearson type III representation is used, which can be described by the following formula:

$$P ( x ) = \frac{1}{βΓ ( p )} {( \frac{\begin{matrix}x & α\end{matrix}}{β} )}^{p - 1} exp ( - \frac{x - α}{β} )$$

giving a range between α and ∞, a maximum, if present, of α+(p−1), a mean value of α+Pβ, a standard deviation of √pβ, a slope of

$$\frac{2}{\sqrt{p}} ,$$

and a curvature of

$$\frac{6}{p} .$$

Instead of the previous value τ, the maximum or the mean value can be used, according to choice, i.e. α=τ−(p−1) or α=τ−pβ, in our model the latter formula for τ being used. Moreover, α>0 must apply, resulting in a restriction for β. Tests have shown that values of the constants p˜1 produce better results, since they allow greater β values.

It can easily be demonstrated that, for a delta distribution of the length of the spring elements or the height distribution of the surface structure, the formulas 3a and 3b describe the case of a constant spring length. For a distribution which covers a comparatively wide range in comparison with the initial step height, polishing of the set-back surface 23 is established immediately at the beginning of the polishing procedure. Moreover, the rate of removal for the set-back surface 23 behaves linearly with the sample density, as already established above. An obvious prerequisite for the distribution of the spring lengths is that only positive spring lengths are used. Moreover, it could be expected that even a minimal spring length would be required. In our experience, the Pearson type III distribution can be used for the distribution of the spring lengths, Γ representing a gamma function. It is evident from FIG. 4 that, by changing α, β and p, aforementioned properties, namely the smallest value, range and the asymmetry of the height distribution, can be set. These parameters are preferably determined experimentally. The resolving of equations 3a and 3b is not always possible analytically, but must be determined by means of a numerical simulation.

Consequently, an improved prediction for the polishing performance of a CMP process on upper surfaces 22 and in set-back surfaces 23 can be made with the aid of the theoretical model described. This is made possible by allowance for the height distribution of the surface structure of the polishing cloth being made in the mathematical model. In the embodiment described, the height distribution is assumed in the form of a Pearson type III distribution. However, other models may also be used for the height distribution of the surface structure of the polishing cloth. What is important here is the finding that the height distribution, and in particular the range of the height distribution, of the surface structure of the polishing cloth has a great influence on the polishing performance during the CMP process. In this respect, both the rate of removal and the planarity of the CMP process are dependent on the height distribution or the range of the height distribution of the surface structure of the polishing cloth. The range of the height distribution in the case of polishing processes that are currently customary lies for instance between 2 μm and 3 μm. Improved planarizing can be achieved by reducing this range.

Consequently, according to the arrangement of FIG. 1, the CMP process can be controlled in dependence on the height distribution of the surface of the polishing cloth. In the case of the CMP process described, both the drive unit 4 and the conditioning device 8 are controlled by the control device 10. For this purpose, fixed control programs are stored in the data memory 12. According to the further development by the method according to the invention, in addition to the known parameters, such as for example the pressing pressure, relative speed between the polishing cloth and the substrate, composition of the CMP fluid, polishing duration, allowance for the height distribution of the surface structure, in particular for a range of the height distribution of the surface structure, of the polishing cloth is preferably also made in the control methods in the data memory 12.

When there is a change of the height distribution of the surface structure of the polishing cloth during the CMP process, if a limit of change is exceeded the control of the CMP process is changed, so that the desired polishing result is obtained. A fixed range of the height distribution of the surface structure is used for example as the limit of change. For example, if there is an undesired change of the height distribution of the surface structure of the polishing cloth, conditioning of the polishing cloth may be started. Moreover, depending on the change, or in dependence on the height distribution of the surface structure of the polishing cloth, the polishing time may be changed. For example, various classes of polishing clothes are available, representing the various classes of ranges of height distributions of the surface structure. Depending on the polishing cloth used, allowance for different values for the height distribution of the surface structure of the polishing cloth is made in the control process by the control unit 10. For example, values for the height distributions of the polishing cloths can be determined experimentally in advance or taken from data sheets of the polishing cloths and made available to the control unit 10. Moreover, in a further embodiment, the ranges of the height distributions of the surface structure of the polishing cloth may be measured during the CMP process with the aid of the sensors 13 and allowed for by the control unit 10.

In a further embodiment of the method according to the invention, the conditioning procedure is also controlled in dependence on the height distribution of the surface structure of the polishing cloth. For this purpose, for example, empirical values for the change over time of the ranges of the height distributions of the polishing cloths are stored in the data memory 12, or the range of the height distribution of the surface structure of the polishing cloth 2 is sensed with the aid of a sensor 13 and passed on to the control unit 10. For example, if the actual range of the height distribution of the surface structure of the polishing cloth deviates from a desired range of values for the range of the height distribution of the surface structure of the polishing cloth, a conditioning procedure may be started. Moreover, even during the performance of the conditioning procedure, the end of the conditioning procedure and/or the manner of the conditioning procedure may be controlled in dependence on the achieved range of the height distribution of the surface structure of the polishing cloth. In this respect, the range of the height distribution of the surface structure of the polishing cloth may be measured in situ during the conditioning procedure or be calculated with the aid of theoretical models.

Furthermore, experimental empirical values for ranges of height distributions for fixed conditioning procedures may be stored in the data memory, so that, depending on a time period of the conditioning procedure, a fixed range of the height distribution of the surface structure of the polishing cloth is achieved, and consequently the conditioning procedure is ended after the time period.

In a further embodiment, the control of the CMP process is carried out in dependence on the height structure of the substrate 5. Preferably, a ratio between the size of the area of the upper surface 22 with respect to the size of the area of the set-back surface 23 is used for this. Moreover, in the control of the CMP process, the depth, i.e. the step height d1 between the upper surface 22 and the set-back surface 23, also has an influence on the theoretical model, and consequently also an influence on the control method of the CMP process.

In a further embodiment, a removal performance, in particular a rate of removal, is determined for the set-back surfaces 23 and/or the upper surfaces 22 with allowance for the range of the height distribution of the surface structure of the polishing cloth. Allowance for the determined removal performance for the upper surface 22 and/or the set-back surface 23 is also made in the control of the CMP process. Consequently, the CMP process is ended when a desired planarity and/or a desired depth of removal of the upper surface 22 and/or of the set-back surface 23 is achieved.

What is claimed is:

1. A method for controlling a CMP process with a polishing cloth, comprising:
polishihg a surface of a substrate, the polishing controlled based on of at least one process parameter; and
allowing for a height distribution of the surface of the polishing cloth in control of the CMP process.

2. The method as claimed in claim 1, wherein, depending on the height distribution of the surface of the polishing cloth, a polishing duration for the CMP process is determined and used for the control of the CMP process.

3. The method as claimed claim 1, wherein allowance for the height structure of the substrate being made in the control method.

4. The method as claimed in claim 3, wherein allowance for a size of an upper surface and a size of a recessed surface of the substrate being made in the height structure.

5. The method as claimed in claim 1, wherein a theoretical model is used for determining an effect of the polishing cloth in the CMP process, and allowance for the height distribution of the surface of the polishing cloth is made in the theoretical model.

6. The method as claimed in claim 5, the polishing cloth being simulated in a form of spring elements in the theoretical model.

7. The method as claimed in claim 1, wherein a removal performance for a recessed surface being determined based on the height distribution of the surface of the polishing cloth.

8. A method for determining a polishing performance of a CMP process of a substrate with a polishing cloth, comprising:
subjecting an upper surface and a set-back surface of the substrate to a polishing procedure with the polishing cloth; and
allowing a height distribution of a surface of the polishing cloth to be made in the determination of the polishing performance for the upper surface and/or the set-back surface.

9. A method for controlling a conditioning procedure for a polishing cloth in a CMP process, comprising:
polishing a surface of the substrate with a polishing cloth, the polishing cloth being subjected to a conditioning procedure, the polishing cloth being worked with a conditioning device during the conditioning procedure to produce a desired surface property of the polishing cloth; and
allowing a height distribution of a surface of the polishing cloth to be made for the beginning and/or the control of the conditioning procedure.

10. A polishing cloth for a CMP process with a surface which has a height distribution, the height distribution having a range which is less than 3 μm.

11. The polishing cloth as claimed in claim 10, the range of the height distribution being less than 1.5 12. The polishing cloth as claimed in claim 10, wherein a number of quality classes is provided for polishing clothes, the quality classes corresponding to different range spans of the height distribution of the surface of the polishing cloth, and a polishing cloth classified in one of the quality classes.
